(19) United States
(12) Patent Application Publication
(10) Pub. No.: US 2026/0190139 A1
(43) Pub. Date: Jul. 2, 2026

(54) DEVICE AND METHOD FOR SWITCHING CHANNEL

(71) Applicant: FRONTSIDE LLC, Seoul (KR)

(72) Inventor: Jeong Soo LEE, Gyeonggi-do (KR)

(21) Appl. No.: 19/437,499

(22) Filed: Dec. 31, 2025

(30) Foreign Application Priority Data
Jan. 2, 2025 (KR) 10-2025-0000484

(51) Int. Cl. H04W 74/00

(52) U.S. Cl. CPC H04W 74/002

(57) ABSTRACT

A method for switching a channel in a wireless local area network is provided. A station which is a member of a basic service set (BSS) receives information on a non-primary channel access (NPCA) primary channel within a BSS bandwidth of the BSS from an associated access point (AP). The station receives an inter-BSS physical layer protocol data unit (PPDU) on a BSS primary channel and switches from the BSS primary channel to the NPCA primary channel for an NPCA operation if (i) channels occupied by the inter-BSS PPDU does not overlap with the NPCA primary channel, and (ii) the station maintains an intra-BSS network allocation vector (NAV) counter with a zero value.

### CROSS-REFERENCE TO RELATED PATENT APPLICATIONS

The present application claims priority under 35 U.S.C. 119 and 35 U.S.C. 365 to Korean Patent Application No. 10-2025-0000484, filed Jan. 2, 2025, whose entire disclosures are hereby incorporated by reference.

### BACKGROUND OF THE DISCLOSURE

### Technical Field

The present disclosure relates to a wireless local area network (WLAN), and more particularly, to a device and method for switching a channel in the WLAN.

### Related Art

A wireless local area network (WLAN) may be formed by one or more access points (APs) that provide a shared wireless communication medium for use by a number of client devices also referred to as stations (STAs).

A single AP and an associated set of STAs may be referred to as a Basic Service Set (BSS). An Overlapping Basic Service Set (OBSS) occurs when two or more of BSSs managed by different APs are close enough to hear each other and are operating on the same frequency channel. The OBSS may cause unnecessary waiting and slow speeds.

WLAN supports transmissions with various bandwidths such as 20 MHz, 40 MHz, 80 MHz, 160 MHz, 320 MHz, etc. A wideband channel includes multiple 20 MHz channel, and each 20 MHz channel can be classified as a primary channel or a secondary channel. The primary channel (for example, the primary 20 MHz channel) must be idle to access a wideband channel (>20 MHz). An AP/STA cannot transmit on any idle secondary channel(s) if the primary channel is busy.

In order to resolve the OBSS problem, a non-primary channel access is proposed. Since an AP/STA can utilize the available secondary channel(s) while the primary channel is busy but the secondary channel(s) are available, the frequency utilization can be improved.

### SUMMARY OF THE DISCLOSURE

The present disclosure provides a method for switching a channel in a wireless local area network.

The present disclosure further provides a device for a wireless local area network.

In an embodiment, a method for switching a channel in a wireless local area network is provided. The method performed by a station which is a member of a basic service set (BSS) includes receiving information on a non-primary channel access (NPCA) primary channel within a BSS bandwidth of the BSS from an associated access point (AP) which corresponds to the BSS, receiving an inter-BSS physical layer protocol data unit (PPDU) on a BSS primary channel, the BSS primary channel being a common channel of operation for all stations that are members of the BSS, the inter-BSS PPDU being transmitted by at least one inter-BSS station which is not a member of the BSS or an AP which does not correspond to the BSS, and switching from the BSS primary channel to the NPCA primary channel for an NPCA operation if all of following conditions (i) and (ii) are met: (i) channels occupied by the inter-BSS PPDU does not overlap with the NPCA primary channel; and (ii) the station maintains an intra-BSS network allocation vector (NAV) counter with a zero value, the intra-BSS NAV counter being updated by an intra-BSS PPDU, the intra-BSS PPDU being transmitted by at least one intra-BSS station which is a member of the BSS or the associated AP.

In another embodiment, a device for a wireless local area network is provided. The device which is a member of a basic service set (BSS) includes a processor, and a memory operatively coupled with the processor and configured to store instructions that, when executed by the processor, cause the device to perform functions. The functions include receiving information on a non-primary channel access (NPCA) primary channel within a BSS bandwidth of the BSS from an associated access point (AP) which corresponds to the BSS, receiving an inter-BSS physical layer protocol data unit (PPDU) on a BSS primary channel, the BSS primary channel being a common channel of operation for all stations that are members of the BSS, the inter-BSS PPDU being transmitted by at least one inter-BSS station which is not a member of the BSS or an AP which does not correspond to the BSS, and switching from the BSS primary channel to the NPCA primary channel for an NPCA operation if all of following conditions (i) and (ii) are met: (i) channels occupied by the inter-BSS PPDU does not overlap with the NPCA primary channel; and (ii) the device maintains an intra-BSS network allocation vector (NAV) counter with a zero value, the intra-BSS NAV counter being updated by an intra-BSS PPDU, the intra-BSS PPDU being transmitted by at least one intra-BSS station which is a member of the BSS or the associated AP.

A STA can access a wireless medium on an alternative primary channel while the primary channel is occupied by inter-BSS traffics.

### BRIEF DESCRIPTION OF THE DRAWINGS

FIG. 1 shows a block diagram of an example wireless communication network.

FIG. 2 shows a block diagram of an example wireless communication device.

FIG. 3 shows an example of wireless channel that includes multiple subchannels.

FIG. 4 shows an example of NPCA operation.

FIG. 5 shows an example of NPCA operation according to an embodiment of the present invention.

FIG. 6 shows an example of NPCA operation according to another embodiment of the present invention.

FIG. 7 shows a method for switching channel according to an embodiment of the present invention.

FIG. 8 shows a method for NPCA operation according to an embodiment of the present invention.

FIG. 9 shows an example of NPCA operation according to an embodiment of the present invention.

FIG. 10 shows an example of NPCA operation according to an embodiment of the present invention.

FIG. 11 shows an example of NPCA operation according to an embodiment of the present invention.

FIG. 12 shows an example of NPCA operation according to an embodiment of the present invention.

### DETAILED DESCRIPTION OF THE EMBODIMENTS

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

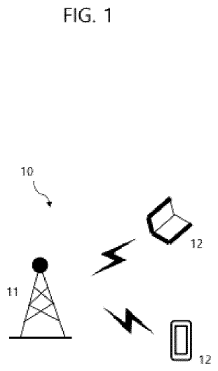

FIG. 1 shows a block diagram of an example wireless communication network.

According to some aspects, the wireless communication network 10 can be an example of a wireless local area network (WLAN) such as a Wi-Fi network (and will hereinafter be referred to as WLAN 10). For example, the WLAN 10 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba, 802.11be and 802.11bn). The WLAN 10 may include numerous wireless communication devices such as an access point (AP) 11 and multiple stations (STAs) 12. While only one AP 11 is shown, the WLAN 10 also can include multiple APs.

Each of the STAs 12 also may be referred to as a mobile station (MS), a mobile device, a mobile handset, a wireless handset, an access terminal (AT), a user equipment (UE), a subscriber station (SS), or a subscriber unit, among other possibilities. The STAs 12 may represent various devices such as mobile phones, personal digital assistants (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, among other possibilities.

A single AP 11 and an associated set of STAs 12 may be referred to as a basic service set (BSS), which is managed by the respective AP 11. The BSS may be identified to users by a service set identifier (SSID), as well as to other devices by a basic service set identifier (BSSID), which may be a medium access control (MAC) address of the AP 11. The AP 11 periodically broadcasts beacon frames (“beacons”) including the BSSID to enable any STAs 12 within wireless range of the AP 11 to “associate” or re-associate with the AP 11 to establish a respective communication link (hereinafter also referred to as a “Wi-Fi link”), or to maintain a communication link, with the AP 11. For example, the beacons can include an identification of a primary channel used by the respective AP 11 as well as a timing synchronization function for establishing or maintaining timing synchronization with the AP 11. The AP 11 may provide access to external networks to various STAs 12 in the WLAN via respective communication link.

To establish a communication link with an AP 11, each of the STAs 12 is configured to perform passive or active scanning operations on frequency channels in one or more frequency bands (for example, the 2.4 GHz, 5 GHz, 6 GHz or 60 GHz bands). To perform passive scanning, a STA 12 listens for beacons, which are transmitted by respective APs 11 at a periodic time interval referred to as the target beacon transmission time (TBTT) (measured in time units (TUs) where one TU may be equal to 1024 microseconds (μs)). To perform active scanning, a STA 12 generates and sequentially transmits probe requests on each channel to be scanned and listens for probe responses from APs 11. Each STA 12 may be configured to identify or select an AP 11 with which to associate based on the scanning information obtained through the passive or active scans, and to perform authentication and association operations to establish a communication link with the selected AP 11. The AP 11 assigns an association identifier (AID) to the STA 12 at the culmination of the association operations, which the AP 11 uses to track the STA 12.

The AP 11 and STAs 12 may function and communicate (via the respective communication links) according to the IEEE 802.11 family of wireless communication protocol standards. These standards define the WLAN radio and baseband protocols for the PHY and medium access control (MAC) layers. The AP 11 and STAs 12 in the WLAN 10 may transmit frames over frequency bands such as the 2.4 GHz band, the 5 GHz band, the 60 GHz band, the 3.6 GHz band, and the 900 MHz band.

Each of the frequency bands may include multiple channels (which may be used as subchannels of a larger bandwidth channel). For example, a physical layer protocol data unit (PPDU) may be transmitted over the 2.4 and 5 GHz bands, each of which is divided into multiple 20 MHz channels. As such, this PPDU is transmitted over a physical channel having a minimum bandwidth of 20 MHz, but larger channels can be formed through channel bonding. For example, the PPDU may be transmitted over physical channels having bandwidths of 40 MHz, 80 MHz, 160 or 320 MHz by bonding together multiple 20 MHz channels (which may be referred to as subchannels).

Uplink (UL) means that the signal (or message or PPDU) is transmitted by a STA to an AP, and downlink (DL) means that the signal (or message or PPDU) is transmitted by the AP to one or more STAs.

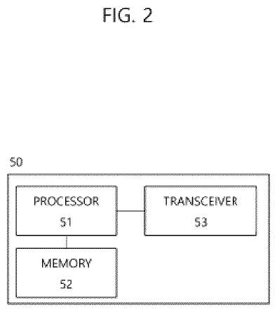

FIG. 2 shows a block diagram of an example wireless communication device.

In some implementations, the wireless communication device 50 can be an example of a device for use in a STA such as one of the STAs 12 described above with reference to FIG. 1. In some implementations, the wireless communication device 50 can be an example of a device for use in an AP such as the AP 11 described above with reference to FIG. 1. The wireless communication device 50 is capable of transmitting (or outputting for transmission) and receiving wireless communications (for example, in the form of wireless packets). For example, the wireless communication device 50 can be configured to transmit and receive packets in the form of PPDUs and/or MAC protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba, 802.11be and 802.11bn.

The wireless communication device 50 can be, or can include, a chip, system on chip (SoC), chipset, package or device that includes one or more processor 51. The processor 51 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 51 processes information received through a transceiver 53, and processes information to be output through the transceiver 53 through the wireless medium. For example, the processor 51 may implement a physical (PHY) layer and/or a MAC layer configured to perform various operations related to the generation and transmission of PPDUs, MPDUs, frames or packets.

A memory 52 can include tangible storage media such as random-access memory (RAM) or read-only memory (ROM), or combinations thereof. The memory 52 also can store non-transitory processor-or computer-executable software code containing instructions that, when executed by the processor 51, cause the wireless communication device 50 to perform various operations described herein for wireless communication, including the generation, transmission, reception and interpretation of PPDUs, MPDUs, frames or packets. For example, various functions of components disclosed herein, or various blocks or steps of a method, operation, process or algorithm disclosed herein, can be implemented as one or more modules of one or more computer programs.

The transceiver 53 generally includes at least one radio frequency (RF) transmitter (or “transmitter chain”) for transmitting radio signals and at least one RF receiver (or “receiver chain”) for receiving radio signals. For example, the RF transmitters and RF receivers may include various DSP circuitry including at least one power amplifier (PA) and at least one low-noise amplifier (LNA), respectively. The RF transmitters and RF receivers may, in turn, be coupled to one or more antennas. For example, in some implementations, the wireless communication device 50 can include, or be coupled with, multiple transmit antennas (each with a corresponding transmit chain) and multiple receive antennas (each with a corresponding receive chain).

A PPDU is a data block or a data unit for WLAN. The PPDU may include a preamble and a data portion. The data portion which includes one or more PHY service data units (PSDUs) and appears after the preamble. The data portion may be referred to as a payload. The preamble of a PPDU can carry information necessary to interpret the PPDU. The preamble can include bandwidth information indication a bandwidth in which the PPDU is transmitted. The preamble can include STA-specific scheduling information such as MCS and RU(resource allocation) allocation. The preamble can include a transmission opportunity (TXOP) information.

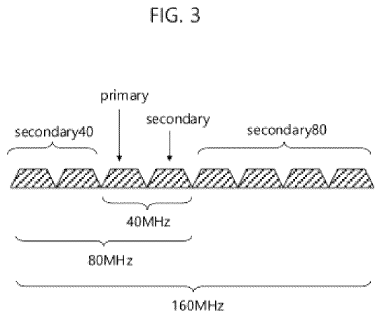

FIG. 3 shows an example of wireless channel that includes multiple subchannels.

A channel map for a frequency band (such as the 2.5 GHz, 5 GHz, 6 GHz frequency band, etc.) may define multiple subchannels. Each subchannel may have a uniform channel width W=20 MHz, but the techniques in this description are not limited to 20 MHz. The channel width W may be smaller than or larger than 20 MHz.

Some WLAN devices are capable of transmitting at higher bandwidths using a wireless channel that is made up of multiple subchannels. When WLAN devices is capable of transmitting at BSS operating channel width is 80 MHz, a group of four subchannels (a primary 20 MHz channel, a secondary 20 MHz channel and a secondary 40 MHz channel) are used. In the example in FIG. 3, an BSS operating channel has a bandwidth of 20 MHz, 40 MHz, 80 MHz and 160 MHz. Although depicted as contiguous subchannels in the channel map, in some implementations, the BSS operating channel may contain one or more subchannel which are not adjacent in the channel map. Additionally, larger groups of channels may be used in some implementations. For example, operating channel has a bandwidth of 320 MHz, 640 MHz or larger. The 320 MHz bandwidth may be divided into sixteen 20 MHz subchannels.

The primary channel is the common channel of operation for all STAs that are members of the BSS. The secondary channel is a channel associated with the primary channel used to create a channel wider than the primary channel. For example, in 80 MHz BSS, the secondary 20 MHz channel adjacent to the primary 20 MHz channel that together form the primary 40 MHz channel of the 80 MHz BSS. The secondary 40 MHz channel adjacent to the primary 40 MHz channel that together form the 80 MHz channel of the 80 MHz BSS.

A WLAN device (AP or STA) can classify a received PPDU into one of three types: inter-BSS PPDU, intra-BSS PPDU and unknown PPDU. The intra-BSS PPDU can be a PPDU transmitted by STAs within its BSS. The inter-BSS PPDU can be a PPDU transmitted by STAs in a neighboring BSS.

The WLAN device can classify a received PPDU into an inter-BSS PPDU if (i) the received PPDU is transmitted by an AP which is not associated with the WLAN device, (ii) the received PPDU is transmitted by an AP not corresponding to WLAN device' BSS (iii) the received PPDU is transmitted by an inter-BSS STA which is not a member of the WLAN device' BSS, (iv) the received PPDU's BSS is not the WLAN device' BSS, or (v) the received PPDU is a DL PPDU and the WLAN device is an AP.

A WLAN device classify a received PPDU as an intra-BSS PPDU if (i) the received PPDU is transmitted by an AP which is associated with the WLAN device, (ii) the received PPDU is transmitted by an AP corresponding to WLAN device' BSS (iii) the received PPDU is transmitted by an intra-BSS STA which is a member of the WLAN device' BSS, or (iv) the received PPDU's BSS is the WLAN device' BSS.

The WLAN device can classify a received PPDU into an unknown PPDU if the received PPDU cannot be determined as an intra-BSS PDDU or inter-BSS PPDU.

The WLAN device would perform a clear channel assessment (CCA) before sending a non-triggered transmission. The CCA is a type of collision avoidance technique. Other types may be referred to as carrier sense, carrier detect, listen-before-talk. CCA is performed by a WLAN device to determine if the wireless medium (such as the group of subchannels) is available or busy (by another transmission). If the wireless medium is in use, the WLAN device may postpone the transmission until the CCA is performed again and the wireless communication medium is idle by another device.

A transmission opportunity (TXOP) is an interval of time during which a STA has the right to initiate frame exchange sequences onto the WM. NAV(network allocation vector) is an indicator, maintained by each STA, of time periods when transmission onto the wireless medium (WM) is not initiated by the STA regardless of whether the STA's clear channel assessment (CCA) function senses that the WM is busy. When the NAV counter is 0, the CS indication is that the medium is idle. When the counter is nonzero, the indication is busy. While a NAV counter is not zero (or NAV indicates busy), the STA cannot access the channel. When a STA receives a PPDU which is not transmitted by the STA or is not destined to the STA, the STA can update NAV (or set/reset NAV counter) according to the TXOP of the received PPDU.

A ‘back-off procedure’ is a channel sending (CS) procedure to confirm that a wireless medium (or a channel) is idle. A STA desiring to initiate transfer of Data frames and/or Management frames needs to invoke the CS mechanism to determine the busy/idle state of the medium. If the medium is busy, the STA defers until the medium is determined to be idle without interruption for a period of time equal to a first interval (for example, extended interframe space (EIFS)) when the last transition to idle medium was a result of a frame detected on the medium that was not received correctly, or equal to a second interval (for example, DCF interframe space (DIFS)) otherwise. After this DIFS or EIFS medium idle time, the, the STA then generates a random backoff count for an additional deferral time before transmitting, unless the back-off counter already contains a non-zero value, in which case the selection of a random number is not needed and not performed. This process minimizes collisions during contention between multiple STAs that have been deferring to the same event.

Hereinafter, the proposed Non-Primary Channel Access (NPCA) is described.

A NPCA is a mechanism for peer STAs to dynamically switch operation from a BSS primary channel to a NPCA primary channel. The NPCA allows STAs within a BSS to switch to an alternate channel during a period of time when OBSS activity is detected on part of the BSS operating channel.

When a STA receives an inter-BSS PPDU on a primary channel (for example, primary 20/40/80/160/320/640 MHz channel), the STA sets a NAV counter of the primary channel and records the occupied primary channel set. According to the conventional IEEE 802.11 protocol, the STA cannot access the entire operating channel when the primary channel is not idle regardless of whether any secondary channel is idle or not. An TXOP is obtained based solely on activity of a primary channel. Therefore, when the primary channel is busy, the STA cannot access the entire channel and cannot initiate any transmission.

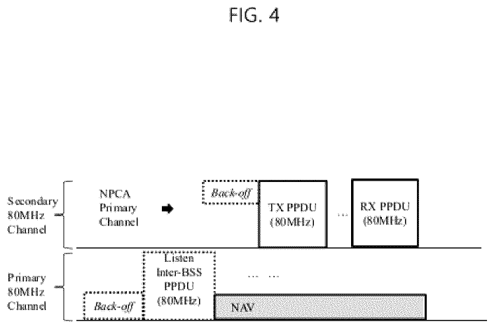

FIG. 4 shows an example of NPCA operation.

An AP may announce the primary channel and/or an NPCA primary channel to STAs. A STA can receive a frame (for example, beacon frame) including information on at least one of the primary channel and the NPCA primary channel. The frame may further information on at least one secondary channel associated with the NPCA primary channel. The primary channel may not overlap with the NPCA primary channel in frequency domain. The NPCA primary channel is used for the NPCA mechanism according to the embodiments described in this disclosure.

The primary channel may be referred to BSS primary channel. The NPCA primary channel may be referred to as various terms such as additional primary channel, selected primary channel, alternative primary channel, etc. When the primary channel is called as the first primary channel, the alternative primary channel may be called as the second primary channel.

The NPCA primary channel may be located in the non-primary channels. The NPCA primary channel may be located in the secondary channels associated with the primary channel. The bandwidth of the NPCA primary channel may be one of 20 MHz, 40 MHz, 80 MHz, 160 MHz and 320 MHz. The primary channel and the NPCA primary channel may be located in different frequency segments (for example, different 80 MHz segments) or in difference frequency bands.

While a NAV counter of the primary channel is set from an inter-BSS PPDU (or any PPDU which is not destined to the STA), the STA can switch from the primary channel to the NPCA primary channel. When the STA can switch to the NPCA primary channel for NPCA operation, the STA may invoke a back-off procedure on the NPCA primary channel.

After the STA moves to the NPCA primary channel, the STA can switch back to the primary channel when the NAV counter of the primary channel is expired.

A STA supporting NPCA can access the WM on the NPCA primary channel while the primary channel is occupied by inter-BSS traffic. When the STA accesses the WM on the NPCA primary channel, the STA needs to maintain NAV counter.

A STA and/or an AP can maintain two NAVs: an intra-BSS NAV and a basic NAV. The intra-BSS NAV is updated by an intra-BSS PPDU. The basic NAV is updated by an inter-BSS PPDU or an unknown PPDU. The intra-BSS NAV counter can be set to a value obtained from an intra-BSS PPDU. The basic NAV counter can be set to a value obtained from an inter-BSS PPDU or an unknown PPDU. If both the NAV counters are 0, the CS indication is that the medium is idle; if at least one of the two NAV timers is nonzero, the CS indication is that the medium is busy.

A STA can update the intra-BSS NAV with the duration information indicated by the received PPDU if (i) the received PPDU is an intra-BSS PPDU, (ii) the indicated duration is greater than the current intra-BSS NAV value, and (iii) the receiver of the received PPDU is not the STA. A STA can update the basic NAV with the duration information indicated by the received PPDU if (i) the received PPDU is an inter-BSS or an unknown PPDU, (ii) the indicated duration is greater than the current basic NAV value, and (iii) the receiver of the received PPDU is not the STA. A STA that is a TXOP holder does not update the intra-BSS NAV with the duration information indicated by the received PPDU.

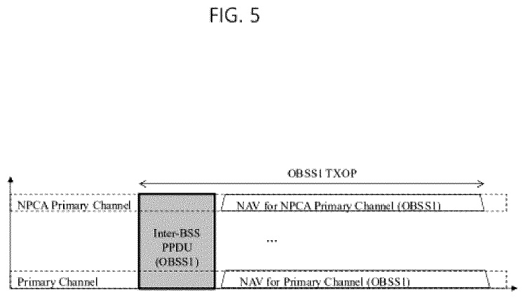

FIG. 5 shows an example of NPCA operation according to an embodiment of the present invention.

When a STA accesses the WM on the NPCA primary channel, the STA can maintain NAV counters for the primary channel and the NPCA primary channel.

A STA can receive an inter-BSS PPDU that occupies at least the primary channel. The STA updates the NAV counter for the primary channel. If the received inter-BSS PPDU occupies the NPCA primary channel, the STA can also update the NAV counter for the NPCA primary channel based on the received PPDU. When a STA accessing the primary channel receives an inter-BSS PPDU occupying both the primary channel and the NPCA primary channel, the STA can update the NAV counters for both the primary channel and the NPCA primary channel.

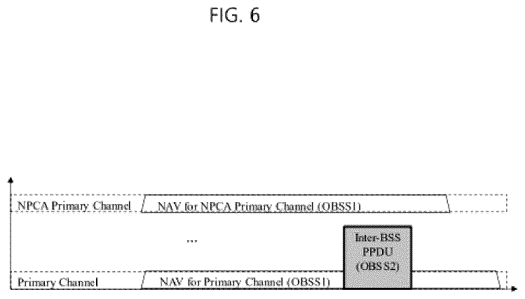

FIG. 6 shows an example of NPCA operation according to another embodiment of the present invention.

While the NAV counters for both the primary channel and the NPCA primary channel are nonzero, a STA receives an inter-BSS PPDU that does not occupy the NPCA primary channel. The STA does not switch to the NPCA primary channel because the virtual CS of the NPCA primary channel is busy. This behavior can help address the issue of blindness on the NPCA.

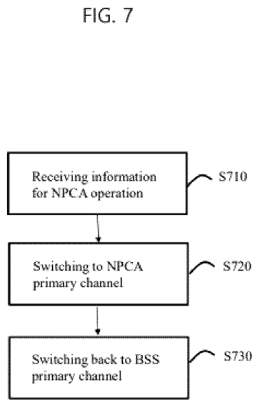

FIG. 7 shows a method for switching channel according to an embodiment of the present invention. This method can be performed by a STA which is a member of BSS managed by an AP.

In step S710, a STA which is a member of a BSS receives information for NPCA operation from an associated AP which corresponds to the BSS. The information can include information on a NPCA primary channel within a BSS bandwidth of the BSS.

In step S720, the STA can switch from the BSS primary channel to the NPCA primary channel when the STA receives an inter-BSS PPDU on the BSS primary channel. The bandwidth of the inter-BSS PPDU which is determined based on bandwidth information in the preamble of the inter-BSS PPDU may be 20, 40, 80, 160 or 320 MHz.

The STA can switch from the BSS primary channel to the NPCA primary channel if at least one of the following options are met.

As a first option, the STA can switch to the NPCA primary channel if (i) channels occupied by the inter-BSS PPDU does not overlap with the NPCA primary channel and (ii) NAV counter(s) for the NPCA primary channel is zero.

As a second option, the STA can switch to the NPCA primary channel if (i) channels occupied by the inter-BSS PPDU does not overlap with the NPCA primary channel and (ii) the STA maintains an intra-BSS NAV counter with zero value.

As a third option, the STA can switch to the NPCA primary channel if (i) channels occupied by the inter-BSS PPDU does not overlap with the NPCA primary channel and (ii) the STA maintains a basic NAV counter with zero value.

As a fourth option, the STA can switch to the NPCA primary channel if (i) channels occupied by the inter-BSS PPDU does not overlap with the NPCA primary channel and (ii) the STA maintains an intra-BSS NAV counter and a basic NAV counter with zero values.

When the STA switches to the NPCA primary channel for NPCA operation, the STA is ready to transmit and receive PPDUs on the NPCA primary channel no later than a NPCA switching delay. A NPCA PPDU transmitted by the STA on the NPCA primary channel includes at least the NPCA primary channel within the BSS bandwidth. The NPCA PPDU does not include any channel(s) occupied by the inter-BSS PPDU which caused the STA to switch from the BSS primary channel to the NPCA primary channel.

In step S730, while operating on the NPCA primary channel, the STA switches back from the NPCA primary channel to the BSS primary channel. The STA can switch back to the BSS primary channel when a switching time expires. The switching time may be determined based on a value derived from the inter-BSS PPDU which caused the STA to switch from the BSS primary channel to the NPCA primary channel. The switching time may include a TXOP duration derived from the inter-BSS PPDU. The various conditions for switching back to the BSS primary channel are proposed in the following embodiments.

When the STA switches back to the BSS primary channel, the STA replaces the current values of the variables QSRC[AC], CW[AC] and the backoff counter for each EDCAF with the values that the STA stored when the STA switched to the NPCA primary channel. The STA resumes the backoff procedure.

When the STA switches back to the BSS primary channel, the STA can invoke the backoff procedure. If the backoff counter that was stored when the STA switched to the NPCA primary channel is zero, the STA invokes the backoff procedure. Especially, if the STA was performing the backoff procedure on the NPCA primary channel (i.e., the backoff counter for the NPCA primary channel is non-zero), the STA requires to invoke the backoff procedure after switching back to the primary channel. Otherwise, more than one STA resuming the backoff procedure with zero backoff counter may collide.

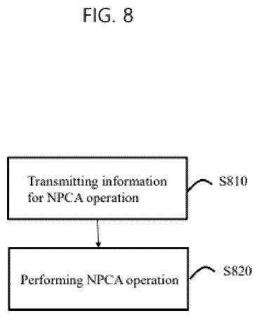

FIG. 8 shows a method for NPCA operation according to an embodiment of the present invention. This method can be performed by an AP which manages a BSS.

In step S810, the AP transmits operation information for NPCA operation to a member STA which is a member of the BSS. The operation information can include information on an NPCA primary channel within a BSS bandwidth of the BSS.

In step S820, the AP operates the NPCA operation with the member STA. The member STA can operate as the STA according to the embodiment shown in FIG. 7.

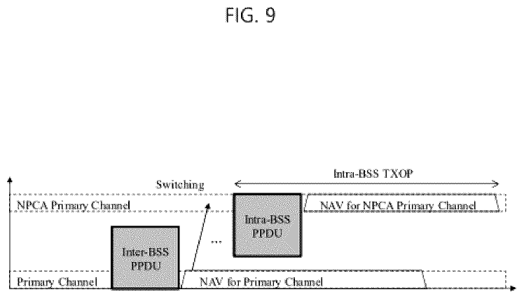

FIG. 9 shows an example of NPCA operation according to an embodiment of the present invention.

After switching to the NPCA primary channel, the STA can decode a PPDU that occupies at least the NPCA primary channel. The STA receiving the PPDU can update the NAV counter for the NPCA primary channel. If the received PPDU also occupies the primary channel, the STA updates the NAV counter for the primary channel based on the received PPDU.

The STA accessing the NPCA primary channel receives an intra-BSS PPDU occupying the NPCA primary channel but not the primary channel. In this case, the STA can update the NAV counter for the NPCA primary channel.

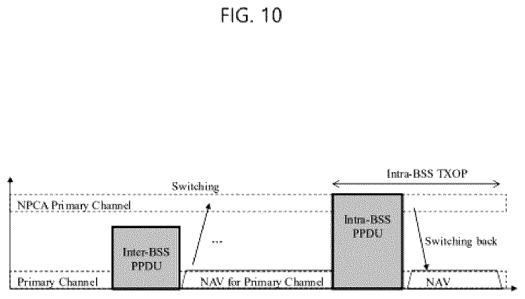

FIG. 10 shows an example of NPCA operation according to an embodiment of the present invention.

A STA accessing the NPCA primary channel receives an intra-BSS PPDU occupying both the BSS primary channel and the NPCA primary channel that is sent from its associated AP. If the intra-BSS PPDU is addressed to the AP and there is no response PPDU from the AP, the NAV can be discarded.

Upon receiving the intra-BSS PPDU, the STA can update the NAV counter for the primary channel and switch back to the BSS primary channel.

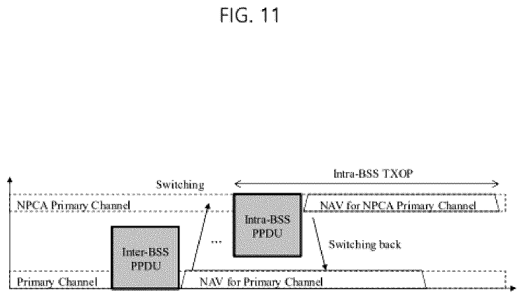

FIG. 11 shows an example of NPCA operation according to an embodiment of the present invention.

A STA accessing the NPCA primary channel receives an inter-BSS PPDU occupying the NPCA primary channel but not the BSS primary channel. The STA can update the NAV counter for the NPCA primary channel. The STA can switch back to the BSS primary channel if the remaining time after the NAV of the NPCA primary channel is less than the duration of the OBSS activity on the BSS primary channel. The STA cannot switch back to the BSS primary channel if the remaining time after the NAV of the NPCA primary channel is greater than the duration of the OBSS activity on the BSS primary channel.

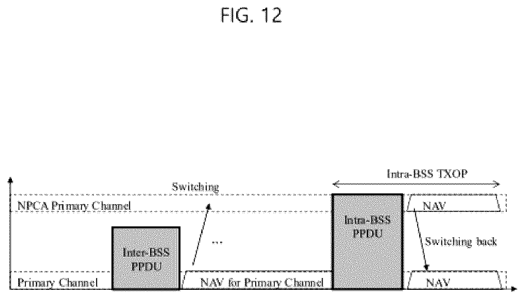

FIG. 12 shows an example of NPCA operation according to an embodiment of the present invention.

A STA accessing the NPCA primary channel receives an inter-BSS PPDU occupying both the BSS primary channel and the NPCA primary channel. The STA can update the NAV counters for the primary channel and NPCA primary channel. The STA can switch back to the BSS primary channel if the remaining time after the NAV of the NPCA primary channel is less than the duration of the OBSS activity on the BSS primary channel.

After switching back to the BSS primary channel, the STA cannot access the BSS primary channel because the virtual CS of the BSS primary channel is busy.

What is claimed is:

1. A method for switching a channel in a wireless local area network, the method performed by a station which is a member of a basic service set (BSS) and comprising:
receiving information on a non-primary channel access (NPCA) primary channel within a BSS bandwidth of the BSS from an associated access point (AP) which corresponds to the BSS;
receiving an inter-BSS physical layer protocol data unit (PPDU) on a BSS primary channel, the BSS primary channel being a common channel of operation for all stations that are members of the BSS, the inter-BSS PPDU being transmitted by at least one inter-BSS station which is not a member of the BSS or an AP which does not correspond to the BSS; and
switching from the BSS primary channel to the NPCA primary channel for an NPCA operation if all of following conditions (i) and (ii) are met:
(i) channels occupied by the inter-BSS PPDU does not overlap with the NPCA primary channel; and
(ii) the station maintains an intra-BSS network allocation vector (NAV) counter with a zero value, the intra-BSS NAV counter being updated by an intra-BSS PPDU, the intra-BSS PPDU being transmitted by at least one intra-BSS station which is a member of the BSS or the associated AP.

2. The method of claim 1, further comprising:
switching back from the NPCA primary channel to the BSS primary channel when a switching time is expired, the switching time being determined based on a value derived from the inter-BSS PPDU.

3. The method of claim 1, wherein a bandwidth of the inter-BSS PPDU is 20, 40, 80, 160 or 320 MHz.

4. A device for a wireless local area network, the device which is a member of a basic service set (BSS) and comprising:
a processor; and
a memory operatively coupled with the processor and configured to store instructions that, when executed by the processor, cause the device to perform functions comprising:
receiving information on a non-primary channel access (NPCA) primary channel within a BSS bandwidth of the BSS from an associated access point (AP) which corresponds to the BSS;
receiving an inter-BSS physical layer protocol data unit (PPDU) on a BSS primary channel, the BSS primary channel being a common channel of operation for all stations that are members of the BSS, the inter-BSS PPDU being transmitted by at least one inter-BSS station which is not a member of the BSS or an AP which does not correspond to the BSS; and
switching from the BSS primary channel to the NPCA primary channel for an NPCA operation if all of following conditions (i) and (ii) are met:
(i) channels occupied by the inter-BSS PPDU does not overlap with the NPCA primary channel; and
(ii) the device maintains an intra-BSS network allocation vector (NAV) counter with a zero value, the intra-BSS NAV counter being updated by an intra-BSS PPDU, the intra-BSS PPDU being transmitted by at least one intra-BSS station which is a member of the BSS or the associated AP.

5. The device of claim 4, wherein the functions further comprise:
switching back from the NPCA primary channel to the BSS primary channel when a switching time is expired, the switching time being determined based on a value derived from the inter-BSS PPDU.

6. The device of claim 4, wherein a bandwidth of the inter-BSS PPDU is 20, 40, 80, 160 or 320 MHz.
